(19) United States
(12) Patent Application Publication
(10) Pub. No.: US 2015/0263374 A1
(43) Pub. Date: Sep. 17, 2015

(54) ENERGY STORAGE DEVICE

(71) Applicant: NATIONAL TAIWAN UNIVERSITY OF SCIENCE AND TECHNOLOGY, Taipei (TW)

(72) Inventors: Bing-Joe Hwang, Taipei (TW); Wei-Nien Su, Taipei (TW); Ming-Yao Cheng, Taipei (TW)

(21) Appl. No.: 14/627,211

(22) Filed: Feb. 20, 2015

(30) Foreign Application Priority Data
Mar. 13, 2014 (TW) 103109187

(51) Int. Cl. H01M 10/02; H01M 10/04; H01M 2/18

(52) U.S. Cl. CPC H01M 10/02; H01M 2/18; H01M 10/04

(57) ABSTRACT

An energy storage device is provided. The energy storage device includes an energy type electrode pair having a first unit energy density and a first unit discharge power; a power type electrode pair having a second unit energy density and a second unit discharge power, and electrically connected to the energy type electrode pair; a housing receiving the energy type electrode pair and the power type electrode pair; a first electrolyte disposed in the energy type electrode pair; and a second electrolyte disposed in the power type electrode pair, wherein the energy type electrode pair forms a first electrically conductive circuit via the first electrolyte, and the power type electrode pair forms a second electrically conductive circuit via the second electrolyte.

### CROSS-REFERENCE TO RELATED APPLICATION AND CLAIM OF PRIORITY

The application claims the benefit of Taiwan Patent Application No. 103109187, filed on Mar. 13, 2014, in the Taiwan Intellectual Property Office, the disclosure of which is incorporated herein in its entirety by reference.

### FIELD OF THE INVENTION

The present invention relates to an energy storage device, and more particularly to an energy storage device simultaneously having at least an energy type electrode pair and at least a power type electrode pair.

### BACKGROUND OF THE INVENTION

Common rechargeable batteries, e.g. the lithium ion battery, can be divided into the energy type battery and the power type battery according to their charge and discharge characteristics. The storage energy of the energy type battery is high, but the power thereof during charge and discharge is low. On the contrary, the storage energy of the power type battery is low, but the power thereof during charge and discharge is high. Therefore, the two batteries can be used for different purposes according to their characteristics. For example, the energy type battery can be used for the product requiring a low output power, e.g. the cellphone, notebook computer, etc., whereas the power type battery can be used for the product requiring a high output power, e.g. the electric car, etc.

However, when in use, the conventional rechargeable battery, whether the energy type battery or the power type battery, usually has a poor pulse discharge, a decreased cyclic capacity and a poor operation under the low temperature environment (i.e. the charge rate).

In order to overcome the drawbacks in the prior art, an energy storage device is provided. The particular design in the present invention not only solves the problems described above, but also is easy to be implemented. Thus, the present invention has the utility for the industry.

### SUMMARY OF THE INVENTION

In accordance with an aspect of the present invention, an energy storage device is provided. The energy storage device uses the combination of at least an energy type electrode pair and at least a power type electrode pair which have an identical electrolyte. This can enhance the fast charge capability of the energy storage device, is suitable for the low temperature operation, and has a better cyclic life.

In accordance with another aspect of the present invention, an energy storage device is provided. The energy storage device includes at least an energy type electrode pair having a first unit energy density and a first unit discharge power, including a first positive electrode having a first surface with a first active material; and a first negative electrode having a second surface with a second active material; at least a power type electrode pair having a second unit energy density and a second unit discharge power, including a second positive electrode having a third surface with a third active material; and a second negative electrode having a fourth surface with a fourth active material, wherein the power type electrode pair is electrically connected to the energy type electrode pair; a housing receiving the energy type electrode pair and the power type electrode pair; a first electrolyte disposed between the first positive electrode and the first negative electrode; and a second electrolyte disposed between the second positive electrode and the second negative electrode.

In accordance with a further aspect of the present invention, a method for manufacturing a battery is provided. The method includes steps of providing at least an energy type electrode pair including a first electrode, a second electrode, a first isolation film disposed between the first electrode and the second electrode, and a first electrolyte, wherein the first electrode, the second electrode and the first isolation film are disposed in the first electrolyte; providing at least a power type electrode pair including a third electrode, a fourth electrode, a second isolation film disposed between the third electrode and the fourth electrode, and a second electrolyte, wherein the third electrode, the fourth electrode and the second isolation film are disposed in the second electrolyte; disposing a third isolation film between the energy type electrode pair and the power type electrode pair; and providing a housing to receive the energy type electrode pair and the power type electrode pair.

In accordance with further another aspect of the present invention, an energy storage device is provided. The energy storage device includes at least an energy type electrode pair having a first unit energy density and a first unit discharge power; at least a power type electrode pair having a second unit energy density and a second unit discharge power, and electrically connected to the energy type electrode pair; a housing receiving the energy type electrode pair and the power type electrode pair; a first electrolyte disposed in the energy type electrode pair; and a second electrolyte disposed in the power type electrode pair, wherein the energy type electrode pair forms a first electrically conductive circuit via the first electrolyte, and the power type electrode pair forms a second electrically conductive circuit via the second electrolyte.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows an energy type electrode pair according to an embodiment of the present invention;

FIG. 2 shows a power type electrode pair according to an embodiment of the present invention;

FIG. 3 shows a battery according to an embodiment of the present invention;

FIG. 4 shows the interior structure of the battery in FIG. 3.

FIG. 5 shows the collocation of energy type electrode pairs and power type electrode pairs in a battery according to another embodiment of the present invention;

FIG. 6 shows the collocation of energy type electrode pairs and power type electrode pairs in a battery according to a further embodiment of the present invention;

FIG. 7 shows the collocation of energy type electrode pairs and power type electrode pairs in a battery according to further another embodiment of the present invention;

FIG. 8 shows a method for manufacturing a battery according to an embodiment of the present invention; and

FIG. 9 shows a method for manufacturing a battery according to another embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

The present invention uses the combination of an energy type electrode pair and a power type electrode pair. The electrode active materials of the energy type electrode pair have the same major constituents as those of the electrode active materials of the power type electrode pair. The energy type electrode pair and the power type electrode pair are connected in parallel to form an electrode set. The energy type electrode pair includes a first electrolyte, and the power type electrode pair includes a second electrolyte. The material of the first electrolyte is identical to that of the second electrolyte. The composition ratio of the inclusion of the material of the first electrolyte can be identical to or different from that of the second electrolyte. Accordingly, a rechargeable energy storage device is formed. The unit energy density of the energy type electrode pair is higher than that of the power type electrode pair. However, the unit discharge power of the energy type electrode pair is lower than that of the power type electrode pair. Therefore, the present invention utilizes the characteristic of the high power capacity of the energy type electrode pair, and the characteristic of the fast response of the power type electrode pair. The energy type electrode pair provides the high energy output, and the power type electrode pair provides the high power demand during fast charge and discharge. In addition, in the high power application, the power type electrode pair also can protect the energy type electrode pair from impact by the high power current. Moreover, because the electrode active materials of the energy type electrode pair have the same major constituents as those of the electrode active materials of the power type electrode pair, and the material of the first electrolyte is identical to that of the second electrolyte, it is easier and simpler to design, manufacture and maintain the energy storage device of the present invention.

The respective characteristics of the energy type electrode pair and the power type electrode pair can be changed by changing the thickness of the electrode, the composition ratio of the active material, conductive additives, adhesives in the electrode, the type of the conductive additives or adhesives, the size and shape of the active materials, and the material, shape or thickness of the current collectors so as to manufacture the energy type electrode pairs and the power type electrode pairs with different required functions, thereby achieving the required characteristics of the energy storage device.

The electrode active materials of the energy type electrode pair have the same major constituents as those of the electrode active materials of the power type electrode pair. The active materials can be applied to various kinds of electrochemical energy storage devices, e.g. the lead-acid battery, nickel-metal hydride battery (Ni-MH), lithium ion battery, lithium-sulfur battery, sodium-sulfur battery, metal-air battery, electrode of the electric double layer capacitor or the capacitance-imitating capacitor, etc. The active material is the material that can perform the electrochemical redox in the energy storage device, thereby generating a potential difference. When the energy storage device is charged, the potential difference is risen. At this time, the positive electrode in the energy storage device performs the electrochemical oxidation, and outputs electrons to the outer loop. Then, the negative electrode receives the electrons output by the positive electrode, and performs the electrochemical reduction. However, when the energy storage device is discharged, which is a spontaneous reaction, the potential difference is decreased. At this time, the negative electrode in the energy storage device performs the electrochemical oxidation, and outputs electrons to the outer loop. Then, the positive electrode receives the electrons output by the negative electrode, and performs the electrochemical reduction.

The material of the electrolyte includes at least one solvent and a dissociable substance. The dissociable substance can be one type of salt. The types of the electrolyte can be selected according to the active material of the electrode. The active material of the electrode is also referred to as the electrode coating, which is divided into the positive electrode coating and the negative electrode coating. In addition, because the electrode active materials of the energy type electrode pair have the same major constituents as those of the electrode active materials of the power type electrode pair, the energy type electrode pair can use the electrolyte having a material identical to that of the electrolyte used by the power type electrode pair. The composition ratio of the inclusion of the material can be identical or different. Ions formed after the dissociation of the electrolyte can move through the porous isolation film disposed between the positive electrode and the negative electrode in the electrode pair to serve as the medium between the positive electrode and the negative electrode.

The collocation of the electrode active materials with the electrolyte is related to the type of the energy storage device. For example, in the lead-acid battery, the lead dioxide serves as the positive electrode, the lead serves as the negative electrode, and the concentrated sulfuric acid serves as the electrolyte. In the lithium ion secondary battery, usually the lithium ion transition metal oxide serves as the positive electrode, e.g. the LiCoO₂, LiMn₂O₄ or LiFePO₄, and the negative electrode is the graphite, artificial graphite, or tin, silicon or the combination thereof. The definitions of the positive electrode and the negative electrode are that the reduction potential of the active material of the positive electrode is higher than that of the active material of the negative electrode. Therefore, under these definitions, the positive electrode has a higher potential than that of the negative electrode.

Moreover, the respective numbers of the energy type electrode pair and the power type electrode pair of the present invention can be determined according to the required power capacity and output power. In addition, the energy type electrode pairs and the power type electrode pairs can be electrically connected in parallel in random order according to actual needs. Various variations of the present invention will be described in the following embodiments.

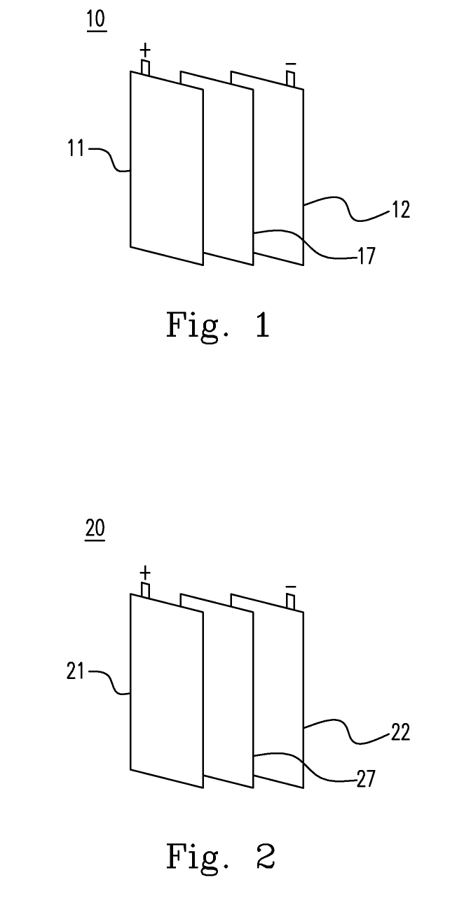

Please refer to FIG. 1, which shows an energy type electrode pair 10 according to an embodiment of the present invention. The energy type electrode pair 10 is composed of a positive electrode 11 and a negative electrode 12. The positive electrode 11 has an internal positive terminal (+), and the negative electrode 12 has an internal negative terminal (−). An isolation film 17 is disposed between the positive electrode 11 and the negative electrode 12. Please refer to FIG. 2, which shows a power type electrode pair 20 according to an embodiment of the present invention. The power type electrode pair 20 is composed of a positive electrode 21 and a negative electrode 22. The positive electrode 21 has an internal positive terminal (+), and the negative electrode 22 has an internal negative terminal (−). An isolation film 27 is disposed between the positive electrode 21 and the negative electrode 22.

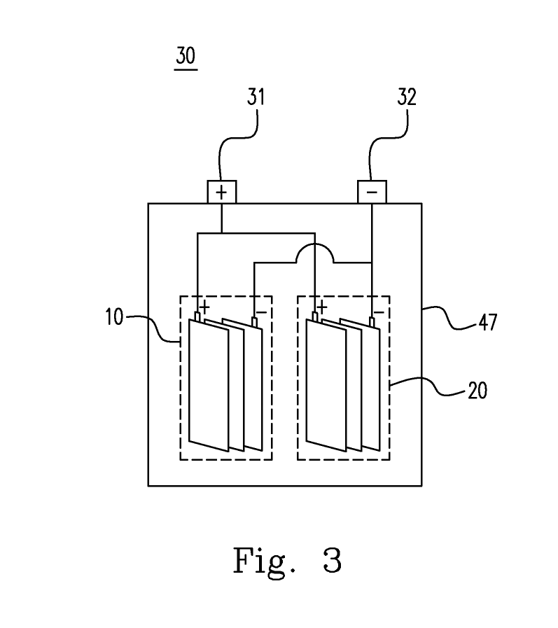

Please refer to FIG. 3, which shows a battery 30 according to an embodiment of the present invention. The energy type electrode pair 10 is electrically connected in parallel to the power type electrode pair 20. The energy type electrode pair 10 and the power type electrode pair 20 are received in a housing 47. An external positive terminal 31 is disposed on the housing 47 and connected to the internal positive terminals (+). An external negative terminal 32 is disposed on the housing 47 and connected to the internal negative terminals (−). In addition, an electrolyte (not shown) is disposed in the housing 47. Accordingly, the battery 30 is formed.

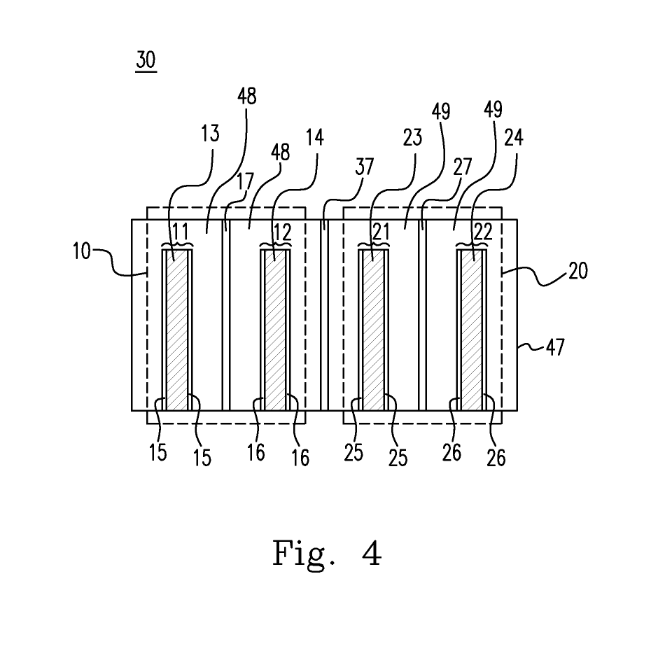

Please refer to FIG. 4, which shows the interior structure of the battery 30 in FIG. 3. The positive electrode 11 of the energy type electrode pair 10 includes a current collecting plate 13 and a positive electrode coating 15. The positive electrode coating 15 covers the surface of the current collecting plate 13. The negative electrode 12 of the energy type electrode pair 10 includes a current collecting plate 14 and a negative electrode coating 16. The negative electrode coating 16 covers the surface of the current collecting plate 14. The positive electrode 21 of the power type electrode pair 20 includes a current collecting plate 23 and a positive electrode coating 25. The positive electrode coating 25 covers the surface of the current collecting plate 23. The negative electrode 22 of the power type electrode pair 20 includes a current collecting plate 24 and a negative electrode coating 26. The negative electrode coating 26 covers the surface of the current collecting plate 24. The isolation film 17 is disposed between the positive electrode 11 and the negative electrode 12, the isolation film 27 is disposed between the positive electrode 21 and the negative electrode 22, and an isolation film 37 is disposed between the energy type electrode pair 10 and the power type electrode pair 20. In this embodiment, the respective materials of the isolation film 17, the isolation film 27 and the isolation film 37 are identical. However, in other embodiments, the respective materials of the isolation film 17, the isolation film 27 and the isolation film 37 can be different. The positive electrode 11, the negative electrode 12, the positive electrode 21, the negative 22, the isolation film 17, the isolation film 17 and the isolation film 37 are all received in the housing 47. The energy type electrode pair 10 further includes a first electrolyte 48. The positive electrode 11, the negative electrode 12 and the isolation film 17 are disposed in the first electrolyte 48. The power type electrode pair 20 further includes a second electrolyte 49. The positive electrode 21, the negative electrode 22 and the isolation film 27 are disposed in the second electrolyte 49. An electrically conductive loop is formed by the first electrolyte 48 and the second electrolyte 49 for the battery 30 to perform the charge and discharge.

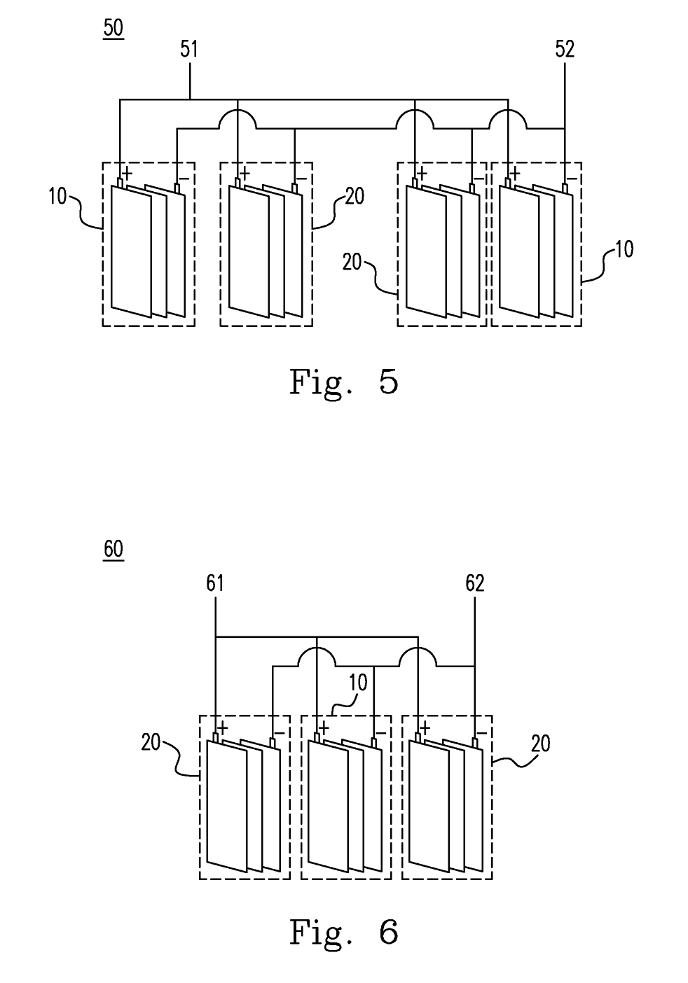

Please refer to FIG. 5, which shows the interior structure of a battery 50 according to another embodiment of the present invention. The battery 50 is equipped with two energy type electrode pairs 10. Two power type electrode pairs 20 are disposed between the two energy type electrode pairs 10. The two energy type electrode pairs 10 are electrically connected in parallel to the two power type electrode pairs 20. In addition, all internal positive terminals (+) are connected to an external positive terminal 51, and all internal negative terminals (−) are connected to an external negative terminal 52.

Please refer to FIG. 6, which shows the interior structure of a battery 60 according to a further embodiment of the present invention. The battery 60 is equipped with two power type electrode pairs 20. A energy type electrode pair 10 is disposed between the two power type electrode pairs 20. The two power type electrode pairs 20 are electrically connected in parallel to the energy type electrode pair 10. Moreover, all internal positive terminals (+) are connected to an external positive terminal 61, and all internal negative terminals (−) are connected to an external negative terminal 62.

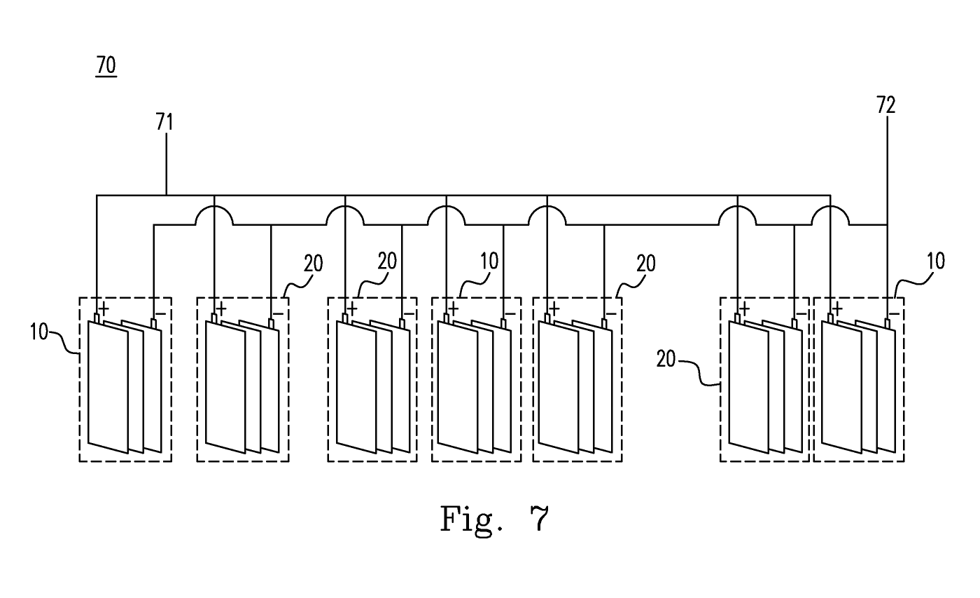

Please refer to FIG. 7, which shows the interior structure of a battery 70 according to further another embodiment of the present invention. The battery 70 is sequentially equipped with an energy type electrode pair 10, two power type electrode pairs 20, an energy type electrode pair 10, two power type electrode pairs 20 and an energy type electrode pair 10. That is, the electrode pairs of the battery 60 are inserted between the electrode pairs of the battery 50. The three energy type electrode pairs 10 are electrically connected in parallel to the four power type electrode pairs 20. Moreover, all internal positive terminals (+) are connected to an external positive terminal 71, and all internal negative terminals (−) are connected to an external negative terminal 72.

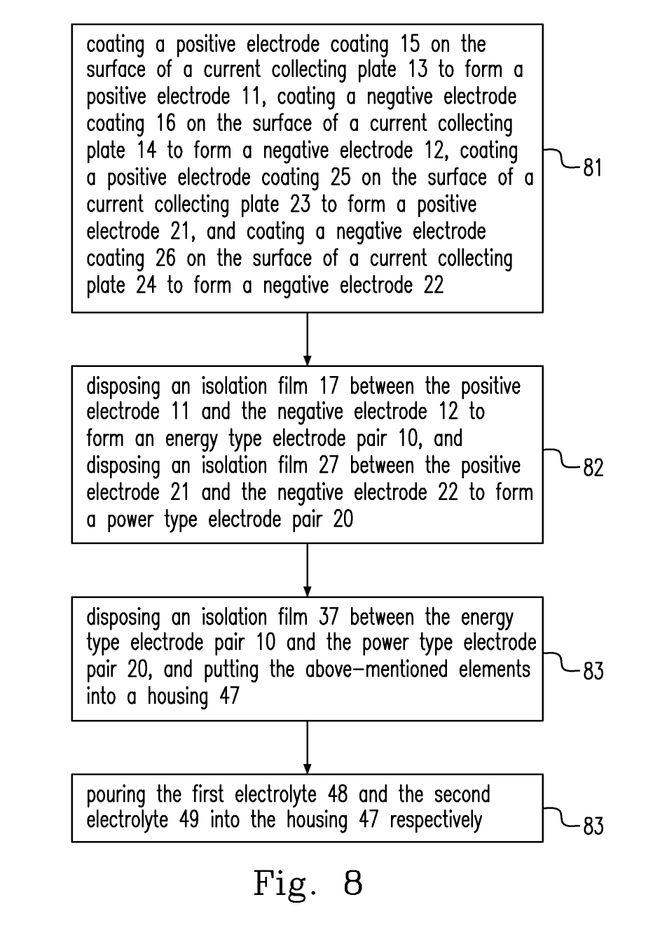

Because the respective materials of the first electrolyte 48 and the second electrolyte 49 can be liquids or colloidal, in practice, the assembling method for the battery varies with the respective materials of the first electrolyte 48 and the second electrolyte 49. As shown in FIG. 8, if the first electrolyte 48 and the second electrolyte 49 are liquids, the assembling method includes the following steps of coating a positive electrode coating 15 on the surface of a current collecting plate 13 to form a positive electrode 11, coating a negative electrode coating 16 on the surface of a current collecting plate 14 to form a negative electrode 12, coating a positive electrode coating 25 on the surface of a current collecting plate 23 to form a positive electrode 21, and coating a negative electrode coating 26 on the surface of a current collecting plate 24 to form a negative electrode 22 (step 81); disposing an isolation film 17 between the positive electrode 11 and the negative electrode 12 to form an energy type electrode pair 10, and disposing an isolation film 27 between the positive electrode 21 and the negative electrode 22 to form a power type electrode pair 20 (step 82); disposing an isolation film 37 between the energy type electrode pair 10 and the power type electrode pair 20, and putting the above-mentioned elements into a housing 47 (step 83); and pouring the first electrolyte 48 and the second electrolyte 49 into the housing 47 respectively (step 84).

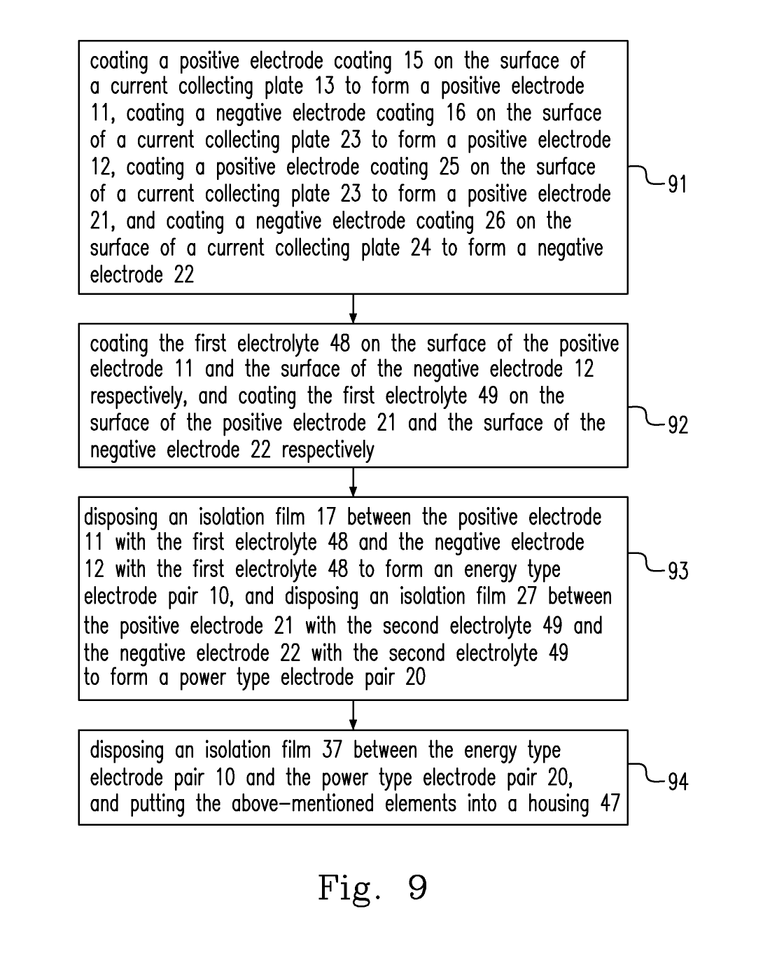

As shown in FIG. 9, if the first electrolyte 48 and the second electrolyte 49 are colloidal, the assembling method includes the following steps of coating a positive electrode coating 15 on the surface of a current collecting plate 13 to form a positive electrode 11, coating a negative electrode coating 16 on the surface of a current collecting plate 14 to form a negative electrode 12, coating a positive electrode coating 25 on the surface of a current collecting plate 23 to form a positive electrode 21, and coating a negative electrode coating 26 on the surface of a current collecting plate 24 to form a negative electrode 22 (step 91); coating the first electrolyte 48 on the surface of the positive electrode 11 and the surface of the negative electrode 12 respectively, and coating the first electrolyte 49 on the surface of the positive electrode 21 and the surface of the negative electrode 22 respectively (step 92); disposing an isolation film 17 between the positive electrode 11 with the first electrolyte 48 and the negative electrode 12 with the first electrolyte 48 to form an energy type electrode pair 10, and disposing an isolation film 27 between the positive electrode 21 with the second electrolyte 49 and the negative electrode 22 with the second electrolyte 49 to form a power type electrode pair 20 (step 93); and disposing an isolation film 37 between the energy type electrode pair 10 and the power type electrode pair 20, and putting the above-mentioned elements into a housing 47 (step 94).

### EMBODIMENTS

1. An energy storage device, comprising at least an energy type electrode pair having a first unit energy density and a first unit discharge power, including a first positive electrode having a first surface with a first active material; and a first negative electrode having a second surface with a second active material; at least a power type electrode pair having a second unit energy density and a second unit discharge power, including a second positive electrode having a third surface with a third active material; and a second negative electrode having a fourth surface with a fourth active material, wherein the power type electrode pair is electrically connected to the energy type electrode pair; a housing receiving the energy type electrode pair and the power type electrode pair; a first electrolyte disposed between the first positive electrode and the first negative electrode; and a second electrolyte disposed between the second positive electrode and the second negative electrode.

2. The energy storage device of Embodiment 1, wherein the energy type electrode pair is connected in parallel to the power type electrode pair; and the first electrolyte and the second electrolyte have an identical material.

3. The energy storage device of any one of Embodiments 1-2, wherein the first electrolyte is a liquid.

4. The energy storage device of any one of Embodiments 1-3, wherein the first electrolyte is colloidal.

5. The energy storage device of any one of Embodiments 1-4, wherein the second electrolyte is a liquid.

6. The energy storage device of any one of Embodiments 1-5, wherein the second electrolyte is colloidal.

7. The energy storage device of any one of Embodiments 1-6, further comprising a first isolation film disposed between the first positive electrode and the first negative electrode.

8. The energy storage device of any one of Embodiments 1-7, further comprising a second isolation film disposed between the second positive electrode and the second negative electrode.

9. The energy storage device of any one of Embodiments 1-8, wherein the first unit energy density is higher than the second unit energy density.

10. The energy storage device of any one of Embodiments 1-9, wherein the first unit discharge power is lower than the second unit discharge power.

11. The energy storage device of any one of Embodiments 1-10, wherein the first active material is identical to the third active material.

12. The energy storage device of any one of Embodiments 1-11, wherein the second active material is identical to the fourth active material.

13. A method for manufacturing a battery, comprising steps of providing at least an energy type electrode pair including a first electrode, a second electrode, a first isolation film disposed between the first electrode and the second electrode, and a first electrolyte, wherein the first electrode, the second electrode and the first isolation film are disposed in the first electrolyte; providing at least a power type electrode pair including a third electrode, a fourth electrode, a second isolation film disposed between the third electrode and the fourth electrode, and a second electrolyte, wherein the third electrode, the fourth electrode and the second isolation film are disposed in the second electrolyte; disposing a third isolation film between the energy type electrode pair and the power type electrode pair; and providing a housing to receive the energy type electrode pair and the power type electrode pair.

14. The method of Embodiment 13, wherein the first electrode has a first surface with a first active material; and the first electrolyte and the second electrolyte have an identical material.

15. The method of any one of Embodiments 13-14, wherein the third electrode has a third surface with the first active material.

16. The method of any one of Embodiments 13-15, wherein the second electrode has a second surface with a second active material.

17. The method of any one of Embodiments 13-16, wherein the fourth electrode has a fourth surface with the second active material.

18. An energy storage device, comprising at least an energy type electrode pair having a first unit energy density and a first unit discharge power; at least a power type electrode pair having a second unit energy density and a second unit discharge power, and electrically connected to the energy type electrode pair; a housing receiving the energy type electrode pair and the power type electrode pair; a first electrolyte disposed in the energy type electrode pair; and a second electrolyte disposed in the power type electrode pair, wherein the energy type electrode pair forms a first electrically conductive circuit via the first electrolyte, and the power type electrode pair forms a second electrically conductive circuit via the second electrolyte.

19. The energy storage device of Embodiment 18, wherein the energy type electrode pair is connected in parallel to the power type electrode pair.

20. The energy storage device of any one of Embodiments 18-19, wherein the first unit energy density is higher than the second unit energy density; and the first unit discharge power is lower than the second unit discharge power.

21. The energy storage device of any one of Embodiments 18-20, wherein the first electrolyte and the second electrolyte have an identical material.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An energy storage device, comprising:
at least an energy type electrode pair having a first unit energy density and a first unit discharge power, including:
a first positive electrode having a first surface with a first active material; and
a first negative electrode having a second surface with a second active material;
at least a power type electrode pair having a second unit energy density and a second unit discharge power, including:
a second positive electrode having a third surface with a third active material; and
a second negative electrode having a fourth surface with a fourth active material, wherein the power type electrode pair is electrically connected to the energy type electrode pair;
a housing receiving the energy type electrode pair and the power type electrode pair;
a first electrolyte disposed between the first positive electrode and the first negative electrode; and
a second electrolyte disposed between the second positive electrode and the second negative electrode.

2. The energy storage device as claimed in claim 1, wherein the energy type electrode pair is connected in parallel to the power type electrode pair.

3. The energy storage device as claimed in claim 1, wherein the first electrolyte is a liquid.

4. The energy storage device as claimed in claim 1, wherein the first electrolyte is colloidal.

5. The energy storage device as claimed in claim 1, wherein the second electrolyte is a liquid.

6. The energy storage device as claimed in claim 1, wherein the second electrolyte is colloidal.

7. The energy storage device as claimed in claim 1, further comprising a first isolation film disposed between the first positive electrode and the first negative electrode.

8. The energy storage device as claimed in claim 1, further comprising a second isolation film disposed between the second positive electrode and the second negative electrode.

9. The energy storage device as claimed in claim 1, wherein the first unit energy density is higher than the second unit energy density.

10. The energy storage device as claimed in claim 1, wherein the first unit discharge power is lower than the second unit discharge power.

11. The energy storage device as claimed in claim 1, wherein the first active material is identical to the third active material.

12. The energy storage device as claimed in claim 1, wherein the second active material is identical to the fourth active material.

13. The energy storage device as claimed in claim 1, wherein the first electrolyte and the second electrolyte have an identical material.

14. A method for manufacturing a battery, comprising steps of:
providing at least an energy type electrode pair including a first electrode, a second electrode, a first isolation film disposed between the first electrode and the second electrode, and a first electrolyte, wherein the first electrode, the second electrode and the first isolation film are disposed in the first electrolyte;
providing at least a power type electrode pair including a third electrode, a fourth electrode, a second isolation film disposed between the third electrode and the fourth electrode, and a second electrolyte, wherein the third electrode, the fourth electrode and the second isolation film are disposed in the second electrolyte;
disposing a third isolation film between the energy type electrode pair and the power type electrode pair; and
providing a housing to receive the energy type electrode pair and the power type electrode pair.

15. The method as claimed in claim 14, wherein:
the first electrode has a first surface with a first active material; and
the first electrolyte and the second electrolyte have an identical material.

16. The method as claimed in claim 15, wherein the third electrode has a third surface with the first active material.

17. The method as claimed in claim 14, wherein the second electrode has a second surface with a second active material.

18. The method as claimed in claim 17, wherein the fourth electrode has a fourth surface with the second active material.

19. An energy storage device, comprising:
at least an energy type electrode pair having a first unit energy density and a first unit discharge power;
at least a power type electrode pair having a second unit energy density and a second unit discharge power, and electrically connected to the energy type electrode pair;
a housing receiving the energy type electrode pair and the power type electrode pair;
a first electrolyte disposed in the energy type electrode pair; and
a second electrolyte disposed in the power type electrode pair, wherein the energy type electrode pair forms a first electrically conductive circuit via the first electrolyte, and the power type electrode pair forms a second electrically conductive circuit via the second electrolyte.

20. The energy storage device as claimed in claim 19, wherein the energy type electrode pair is connected in parallel to the power type electrode pair.

21. The energy storage device as claimed in claim 19, wherein:
the first unit energy density is higher than the second unit energy density; and
the first unit discharge power is lower than the second unit discharge power.
